(19) United States
(12) Patent Application Publication
(10) Pub. No.: US 2014/0340224 A1
(43) Pub. Date: Nov. 20, 2014

(54) SYSTEM AND METHOD FOR MONITORING DUST LEVEL OF FANS

(71) Applicants: HON HAI PRECISION INDUSTRY CO., LTD., New Taipei (TW); HONG FU JIN PRECISION INDUSTRY (Shenzhen) CO., LTD, Shenzhen (CN)

(72) Inventor: BI-HUI TAN, Shenzhen (CN)

(73) Assignees: HON HAI PRECISION INDUSTRY CO., LTD., New Taipei (TW); HONG FU JIN PRECISION INDUSTRY (Shenzhen) CO., LTD, Shenzhen (CN)

(21) Appl. No.: 14/108,533

(22) Filed: Dec. 17, 2013

(30) Foreign Application Priority Data
May 16, 2013 (CN) 2013101807263

(51) Int. Cl. G08B 21/18

(52) U.S. Cl. CPC G08B 21/182
USPC 340/540

(57) ABSTRACT

A system for monitoring dust level of a plurality of fans of a server includes a data processing control unit, a number of fans, and a plurality of sensing units. Each of the fans is connected to the data processing control unit. The sensing units are coupled to the data processing control unit, and each of the sensing units is configured to measure a dust level of each of the fans and send a measurement signal of the dust level to the data processing control unit. The data processing control unit is configured to determine whether the measurement signal is greater than a threshold value and send an alarm signal when the dust level is greater than the threshold value.

### BACKGROUND

1. Technical Field

The disclosure generally relates to methods and systems for monitoring dust levels of fans.

2. Description of Related Art

A plurality of fans may be used to dissipate heat generated by servers. However, dust accumulates on the fans may affect operation of the fans. However, it may be inconvenient to check the fans regularly. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of a system for monitoring dust levels of fans.

FIG. 2 is a flowchart showing one embodiment of a method for monitoring dust levels of fans.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

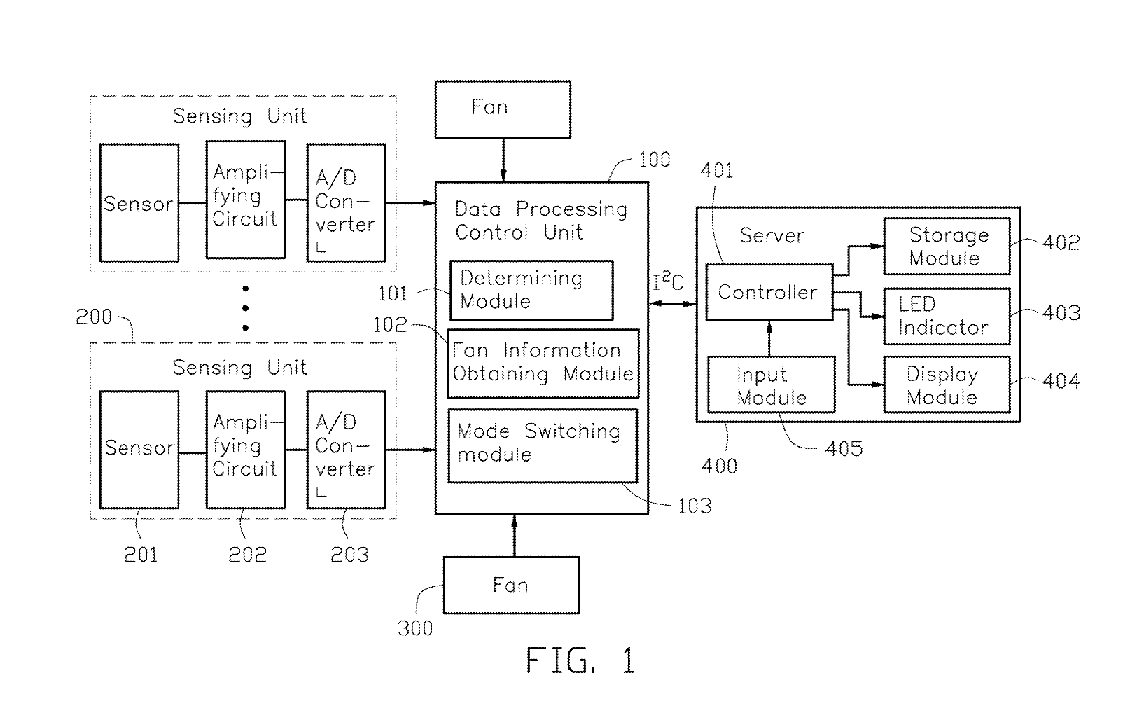

FIG. 1 shows one embodiment of a system configured to monitor dust levels of a plurality of fans 300. The system includes a data processing control unit 100, and a plurality of sensing units 200. Each of the sensing units 200 is coupled to the data processing control unit 100 and configured to sense a dust level of a corresponding fan 300. The fans 300 are configured to dissipate heat generated by a server 400, and each of the fans 300 is coupled to the data processing control unit 100. The server 400 is coupled to the data processing control unit 100 by an inter-integrated circuit (I²C). In one embodiment, the server 400 can operate in a low-power consumption mode and a high-power consumption.

Each of the sensing units 200 is configured to sense the dust level of a corresponding fan 300. Each of the plurality of sensing units 200 includes a sensor 201, an amplifying circuit 202, and an analog to digital (A/D) converter 203. The sensor 201 is coupled to the amplifying circuit 202 and senses the dust level of the corresponding fan 300. The sensor 201 sends a measurement signal of the dust level to the amplifying circuit 202. The amplifying circuit 202 is coupled to the A/D converter 203 and amplifies the measurement signal and sends the amplified measurement signal to the A/D converter 203. The A/D converter 203 is coupled to the data processing control unit 100. The A/D converter 203 converts the amplified measurement signal, which is in the form of an analog signal, to a digital signal and sends the converted measurement signal to the data processing control unit 100.

The data processing control unit 100 includes a determining unit 101, a fan information obtaining unit 102, and a mode switching unit 103. The determining unit 101 determines whether the converted measurement signal is greater than a threshold value. If the converted measurement signal is greater than the threshold value, the fan information obtaining unit 102 obtains information of corresponding fan 300, each fan 300 has a code number, for example. The determining unit 101 further determines if the converted measurement signal is greater than a predetermined value larger than the threshold value. If the converted measurement signal is greater than the predetermined value, the determining unit 101 sends a mode switching command to the server 400.

The server 400 is connected to the data processing control unit 100 by an Inter-Integrated circuit (I²C) and includes a controller 401, a storage module 402, a light-emitting diode (LED) indicator 403, a display module 404, and an input module 405. The controller unit 100 receives the converted measurement signal and saves the converted measurement signal to the storage module 402. If the converted measurement signal is greater than the threshold value, the controller 401 sends an alarm signal to the LED indicator 403. The LED indicator 403 powers on to indicate that the corresponding fan 300 needs to be cleaned. The display module 404 displays the information and the converted measurement signal.

The input device 405 allows a user to set the threshold value and the predetermined value. The input device 405 can be a keyboard, a mouse, a touch pad, or other suitable device that can be used to input information.

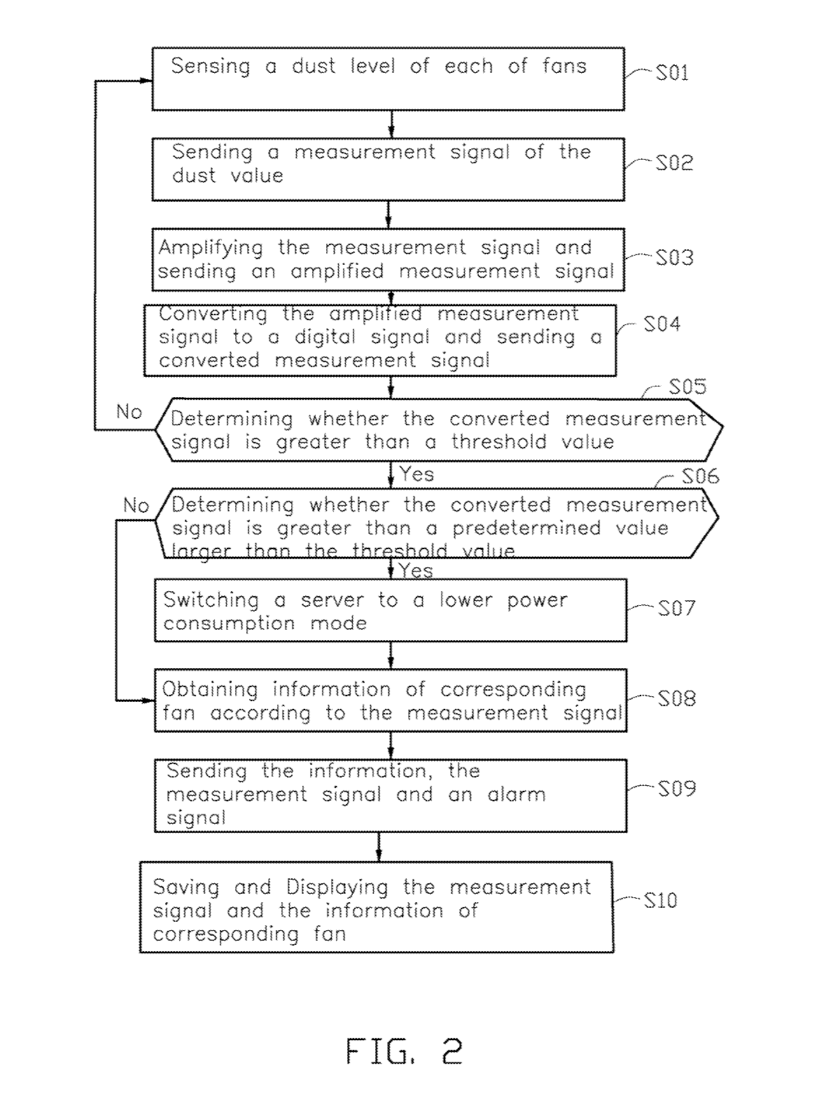

FIG. 2 is a flowchart showing one embodiment of a method for monitoring dust density of the fans 300. The method comprises the following steps.

In step S01, the sensor 201 of each of the sensing units 200 senses a dust level of each of the plurality of fans 300.

In step S02, the sensor 201 sends a measurement signal of the dust level to the data processing control unit 100.

In step S03, the amplifying circuit 202 of each of the plurality of sensing units 200 amplifies the measurement signal and sends an amplified measurement signal to the A/D converter 203.

In step S04, the A/D converter 203 of each of the plurality of sensing units 200 converts the amplified measurement signal to a digital signal and sends a converted measurement signal to the data processing control unit 100.

In step S05, the determining unit 101 determines whether the converted measurement signal is greater than the threshold value. If the converted measurement signal is greater than the threshold value, the method goes to step S06. If the converted measurement signal is not greater than the threshold value, the method goes to step S01.

In step S06, the determining unit 101 further determines whether the converted measurement signal is greater than the predetermined value. If the converted measurement signal is greater than the predetermined value, the method goes to step S07. If the converted measurement signal is not greater than the predetermined value, the method goes to step S08.

In step S07, the mode switching unit 103 switches the server 100 to the low-power consumption mode.

In step S08, the fan information obtaining unit 103 obtains information of corresponding fan 300 according to the converted measurement signal.

In step S09, the fan information obtaining unit 103 sends the information of corresponding fan and the alarm signal.

In step S10, the storage module 402 saves the converted measurement signal and the information, and the display module 404 displays the converted measurement signal and the information. The LED indicator 403 is powered on.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A dust level monitoring system comprising:
a data processing control unit configured to be connected to a plurality of fans; and
a plurality of sensing units coupled to the data processing control unit, each of the plurality of sensing units being configured to measure a dust level of each of the plurality of fans and send a measurement signal of the dust level to the data processing control unit,
wherein the data processing control unit is configured to determine whether the measurement signal of the dust level is greater than a threshold value and send an alarm signal when the measurement signal is greater than the threshold value.

2. The dust level monitoring system of claim 1, wherein the data processing control unit comprises a determining unit, the determining unit is configured to determine whether the measurement signal is greater than the threshold value.

3. The dust level monitoring system of claim 2, wherein the data processing control unit further comprises a fan information obtaining unit, the fan information obtaining unit is configured to obtain information of a fan when the measurement signal of the fan is measured to be greater than the threshold value and send the information of the fan and the alarm signal to a server which the fan is associated with.

4. The dust level monitoring system of claim 2, wherein the data processing control unit further comprises a mode switching module, the determining unit is further configured to determine whether the measurement signal of the dust level is greater than a predetermined value, and the predetermined value is larger than the threshold value; the mode switching module is configured to switch a server associated with the fan into a low power consumption mode when the measurement signal of the dust level is greater than the predetermined value.

5. The dust level monitoring system of claim 1, wherein each of the plurality of sensing units comprises a sensor, and the sensor is configured to sense the dust level and send the measurement signal of the dust level.

6. The dust level monitoring system of claim 5, wherein each of the sensing units further comprises an amplifying circuit coupled to the sensor, and the amplifying circuit is configured to amplify the measurement signal and send an amplified measurement signal.

7. The dust level monitoring system of claim 6, wherein each of the plurality of sensing units further comprises an analog to digital (A/D) converter coupled to the data processing control unit and the amplifying circuit, and the A/D converter is configured to convert the amplified measurement signal of the dust level to a digital signal and send a converted measurement signal.

8. The dust level monitoring system of claim 7, wherein the data processing control unit is configured to determine whether the converted measurement signal of the dust level is greater than a threshold value and send an alarm signal when the converted measurement signal is greater than the threshold value.

9. A dust level monitoring method comprising:
sensing a dust level of each of a plurality of fans;
sending a measurement signal of the dust level to a data processing control unit;
determining whether the measurement signal of the dust level of a fan of the plurality of fans is greater than a threshold value;
sending an alarm signal when the measurement signal is greater than the threshold value.

10. The dust level monitoring method of claim 9, wherein when the measurement signal is determined to be greater than the threshold value, the method further comprises:
obtaining information of the fan according to the measurement signal; and
sending the information of the fan and the alarm signal.

11. The dust level monitoring method of claim 9, wherein when the measurement signal of the dust level is greater than the threshold value, the method further comprises:
determining whether the measurement signal is greater than a predetermined value, and the predetermined value is larger than the threshold value; and
switching a server associated with the fan into a low power consumption mode when the dust level is greater than the predetermined value.

12. The dust level monitoring method of claim 9, wherein the method further comprises:
amplifying the measurement signal and sending an amplified measurement signal;
converting the amplified measurement signal to a digital signal and sending an converted measurement signal.

13. The dust level monitoring method of claim 12, wherein the method further comprises:
determining whether the converted measurement signal of the dust level is greater than a threshold value and send an alarm signal when the converted measurement signal is greater than the threshold value.
